(19) United States
(12) Patent Application Publication
(10) Pub. No.: US 2021/0345304 A1
(43) Pub. Date: Nov. 4, 2021

(54) DETERMINING DOWNLINK CONTROL FORMAT BASED ON RELIABILITY

(71) Applicant: Telefonaktiebolaget LM Ericsson (publ), Stockholm (SE)

(72) Inventors: Florent MUNIER, Västra Frölunda (SE); Niklas ANDGART, Södra Sandby (SE); Laetitia FALCONETTI, Järfälla (SE); Kittipong KITTICHOKECHAI, Järfälla (SE); Alexey SHAPIN, Luleå (SE); Mårten SUNDBERG, Årsta (SE)

(21) Appl. No.: 16/474,802

(22) PCT Filed: Feb. 11, 2019
(86) PCT No.: PCT/SE2019/050112

§ 371 Date: Jun. 28, 2019

Related U.S. Application Data
(60) Provisional application No. 62/710,371, filed on Feb. 16, 2018.

(51) Int. Cl. H04W 72/04

(52) U.S. Cl. CPC H04W 72/042

(57) ABSTRACT

A method, wireless device and network node for determining a format of downlink control information (DCI) are disclosed. According to one aspect, a network node selects a format of a DCI message from a set of at least two DCI message formats based on one or more of a service type provided to the wireless device, a characteristic of a physical downlink control channel, and a measure of channel quality. The network node signals the DCI message of the selected format to the wireless device . . . . According to another aspect, a wireless device WD determines a format of the DCI message and decodes the DCI message based on the determined format of the DCI message.

### TECHNICAL FIELD

The present disclosure relates to wireless communications, and in particular, to determining downlink control information (DCI) size selection and formatting based on reliability.

### BACKGROUND

In Long Term Evolution (LTE) and New Radio (NR) wireless communication systems, there are many techniques to improve spectrum efficiency and radio resource utilization, but one of the most important techniques is Radio Resource Management (RRM). With RRM, a scheduler, typically located in a network node, such as a base station, controls a buffer state of all connections and carefully allocates time-frequency resources for the connections in a radio interface. For being able to receive or transmit data to or from user equipment or a wireless device (WD), a network node informs the WD about allocated resources in the downlink (DL), i.e., from, the network node to the WD, or the uplink (UL), i.e., from the WD to the network node, by sending a special signaling message called Downlink Control Information (DCI). The DCI message is typically sent over the Physical Downlink Control Channel (PDCCH). An example of this process in the DL and the UL is shown in FIG. 1. As shown in FIG. 1, the DCI message specifies when during the Physical Downlink Shared Channel (PDSCH) the WD receives data on the downlink and further specifies when during the Physical Uplink Shared Channel the WD transmits data on the uplink.

There are many formats of DCI messages and the use of a format depends on a few factors such as transmission mode, transmission direction (whether DL or UL), traffic type, etc. The size of the message may change along with DCI format and the message can be approximately 15 to 50 bits in length. Typically, the DCI message contains the following information:
Frequency resource allocation information (i.e., a set of Resource Block (RB) assignments or Resource Block Group (RBG) assignments);
Hybrid Automatic Repeat Request (HARQ) process number;
New Data Indicator (NDI);
Modulation and Coding Scheme (MCS);
Redundancy Version (RV);
Transmit Power Control (TPC) command;
Other information, e.g., header, hopping related information, localized or distributed allocation flag, etc.

The size of the DCI message has an impact when the DCI message is encoded by a channel code (such as a convolutional code, turbo code or Polar code as used in 4th and 5th generation networks). For example, the biggest possible size of an encoded message is limited by the highest aggregation level (AL) of control channel elements (CCE) allowed in the system. In other words, there is a maximum allowed size of the encoded DCI message. This limitation, together with a shortest DCI message size, bounds the lowest possible channel coding rate for a DCI message. Hence, signaling reliability is also bounded.

Discussion is ongoing in the Third Generation Partnership Project (3GPP) on mechanisms to support Ultra Reliable Low Latency Communication (URLLC) in LTE and NR. URLLC requires very robust physical channel design, applying to both signaling and traffic channels. URLLC requires lower latency than some other services delivered to the WD.

LTE data transmissions can be scheduled on three different durations: subframe, slot, and subslot. For slot transmission, each slot of a subframe can be independently scheduled. For subslot transmission, the subframe is divided into 6 subslots of 2 or 3 orthogonal frequency division multiplex (OFDM) symbols each, as shown in FIG. 2. Pattern 1 in FIG. 2 is used when the physical downlink control channel (PDCCH) is 1 or 3 OFDM symbols long and pattern 2 is used for 2 OFDM symbol long PDCCH.

In NR, the baseline length of data transmissions is a slot. If shorter transmission is desired, the network node such a base station, e.g., eNB, can schedule a mini-slot, also referred to as Type B transmission, which can take any length from one OFDM symbol to the number of OFDM symbols in a slot minus 1.

In LTE, cell-specific reference signals (CRS) are used for estimating the channel and demodulating the PDCCH. CRS can also be used for demodulation of the physical data channel. FIG. 3 illustrates an example of the position of CRS resource elements (REs) used for 2-port CRS within a subframe and a physical resource block.

In the LTE standard Release-8, a DCI message is sent only on the PDCCH. The first one to four OFDM symbols in a subframe, depending on the configuration, are reserved to the PDCCH. In LTE standard Release-11, an enhanced physical downlink control channel (EPDCCH) was introduced, in which physical resource block (PRB) pairs are reserved to exclusively contain EPDCCH transmissions. This implementation excludes from the PRB pair the one to four first symbols that may contain control information to WDs of releases earlier than Release-11. DCI messages can be transmitted over the EPDCCH if configured over the radio resource channel (RRC). The EPDCCH uses a WD-specific demodulation reference signal (DMRS), which enables applying beamforming for the control channel. In LTE Release-15, a short physical downlink control channel (SPDCCH) was introduced for sending the DCI message for a slot or subslot data transmission. SPDCCH demodulation is based on either CRS or DMRS.

The PDCCHs, EPDCCHs and SPDCCHs are transmitted over radio resources that are, or can be, shared between several WDs. A downlink (DL) control channel includes smaller parts, known as control channel elements (CCE) for the PDCCH, and enhanced CCE (ECCE) for the EPDCCH and Short CCE (SCCE) for the SPDCCH. Link adaptation of the DL control channel may be accomplished by controlling the number of used (short or enhanced (S/E)) CCEs. The number of resource elements (REs) per (S/E) CCE plays a role when deciding the aggregation level (i.e., the number of (S/E) CCEs) of a DL control channel candidate. The number of REs per (S/E) CCE may be different for PDCCH, EPDCCH and SPDCCH.

For the PDCCH, a CCE maps to 36 resource elements. Reference signals are excluded and it is ensured that 36 REs are available per CCE for the PDCCH. An ECCE has also 36 REs but the number of REs available for EPDCCH mapping is generally fewer than this because many REs are occupied by other signals such as CRS and they are excluded from the physical resources that the EPDCCH can map to. An SCCE has different numbers of REs depending on the demodulation type. For CRS based SPDCCH, an SCCE is composed of 48 resource elements (REs). However, the number of REs available for SPDCCH mapping is generally fewer than this because many REs are occupied by other signals such as CRS and they are excluded from the physical resources the SPDCCH can map to. FIG. 4 shows that the SPDCCH in the first OFDM symbol of subslot #3 and subslot #5 contain fewer REs than the SPDCCH in subslot #4 because the modulated symbols of the SPDCCH are not mapped on REs used for CRS in subslot #4.

Since the highest aggregation level (AL) on the PDCCH and size of the DCI message limit the DCI transmission reliability, it becomes unrealistic to achieve ultra-reliability and low latency for URLLC services with existing properties of LTE and NR. If the WD operates at low signal to noise ratio (SNR) and low signal to interference plus noise ratio (SINR), the WD may not be able to receive signaling with the required reliability. Hence, the WD can miss transmissions which results in falling beyond allowed latency limits. At the same time, reducing the DCI message size will introduce restrictions in the flexibility of the RRM procedures, and hence it is only of interest to use a DCI message of smaller size when required by performance limitations.

### SUMMARY

Some embodiments advantageously provide methods, wireless devices and network nodes for downlink control information (DCI) message size selection and formatting based at least in part on reliability. Some embodiments improve control signaling reliability for URLLC services, and at the same time minimize restrictions on RRM as compared with known solutions to provide flexibility of the WD operation in the network, and to provide schemes for configuration and usage of the compact DCI message.

Thus, in some embodiments, a network node is configured to communicate with a wireless device, WD. The network node includes processing circuitry configured to select a format of a Downlink Control Information, DCI, message from a set of at least two DCI message formats based on one or more of: a service type provided to the WD, a characteristic of a physical downlink control channel, and a measure of channel quality. The processing circuitry is further configured to signal the DCI message of the selected format to the WD.

According to this aspect, in some embodiments, the selected format is for a size selected to be a smaller one of two different DCI message sizes when the service type requires lower latency than other service types provided to the WD. In some embodiments, the service type is Ultra Reliable Low Latency Communication, URLLC. In some embodiments, the format is selected based at least in part on an aggregation level of a Physical Downlink Control Channel, PDCCH. In some embodiments, the selected format is for a size selected to be a smaller one of two different DCI message sizes based on a length of the physical downlink control channel. In some embodiments, the measure of channel quality is a Channel Quality Index, measured Timing Advance, TA, a Signal to Noise Ratio, SNR, a Signal to Interference plus Noise Ratio, SINR, a Reference Signal Received Power, RSRP, or a Reference Signal Received Quality, RSRQ. In some embodiments, selecting a format of the DCI message based on a measure of channel quality includes comparing the measure of channel quality to at least one threshold. In some embodiments, the at least one threshold is sent to the WD by Radio Resource Control, RRC, signaling. In some embodiments, the format of the DCI message that is selected depends on which one of a subframe, slot or subslot of the physical downlink control channel the DCI message is transmitted. In some embodiments, the format of the DCI message that is selected depends on a periodicity or a number of repetitions configured for scheduling requests.

According to another aspect, a method in a network node configured to communicate with a wireless device, WD is provided. The method includes selecting (S134) a format of a Downlink Control Information, DCI, message from a set of at least two DCI message formats based on one or more of: a service type provided to the WD, a characteristic of a physical downlink control channel, and a measure of channel quality. The method also includes signaling (S136) a DCI message of the selected format to the WD.

According to this aspect, in some embodiments, the selected format is for a size selected to be a smaller one of two different DCI message sizes when the service type requires lower latency than other service types provided to the WD In some embodiments, the service type is size is Ultra Reliable Low Latency Communication, URLLC. In some embodiments, the format is selected based at least in part on an aggregation level of a Physical Downlink Control Channel, PDCCH. In some embodiments, the format is for a size selected to be a smaller one of two different DCI message sizes based on a length of the physical downlink control channel. In some embodiments, the measure of channel quality is a Channel Quality Index, measured Timing Advance, TA, a Signal to Noise Ratio, SNR, a Signal to Interference plus Noise Ratio, SINR, a Reference Signal Received Power, RSRP, or a Reference Signal Received Quality, RSRQ. In some embodiments, selecting a format of the DCI message based on a measure of channel quality includes comparing the measure of channel quality to at least one threshold. In some embodiments, the at least one threshold is sent to the WD by Radio Resource Control, RRC, signaling. In some embodiments, the format of the DCI message that is selected depends on which one of a subframe, slot and subslot of the physical downlink control channel the DCI message is transmitted. In some embodiments, the format of the DCI message that is selected depends on a periodicity or a number of repetitions configured for scheduling requests.

According to yet another aspect, a wireless device, WD, configured to communicate with a network node is provided. The WD includes processing circuitry configured to determine a downlink control information, DCI, message format, and to decode the DCI message based on the determined format, the format being based on one or more of: a service type provided to the WD, a characteristic of a physical downlink control channel, and a measure of channel quality.

According to this aspect, in some embodiments, the DCI message format is determined via radio resource control, RRC, signaling from the network node. In some embodiments, the processing circuitry is further configured to determine at least one threshold which the WD is configured to compare to a measure of channel quality to select a DCI message format. In some embodiments, the DCI message format indicates a size of the DCI message to be selected by the WD.

According to another aspect, method implemented in a WD is provided. The method includes determining a downlink control information, DCI, message format, and decoding the DCI message based on the determined format, the format being based on one or more of: a service type provided to the WD, a characteristic of a physical downlink control channel, and a measure of channel quality.

According to this aspect, in some embodiments, the DCI message format is determined via radio resource control, RRC, signaling from the network node. In some embodiments, the method further includes determining at least one threshold which the WD is configured to compare to a measure of channel quality to select a DCI message format. In some embodiments, the DCI message format indicates a size of the DCI message to be selected by the WD.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is an illustration of examples of downlink and uplink resource allocation;

FIG. 2 is a pattern of subslot transmissions;

FIG. 3 is an illustration of resource element positions for 2-port cell-specific reference signals (CRS);

FIG. 4 is an illustration of CRS overhead and subslot boundaries;

FIG. 5 is a schematic diagram of an exemplary network architecture illustrating a communication system connected via an intermediate network to a host computer according to the principles in the present disclosure;

FIG. 6 is a block diagram of a host computer communicating via a network node with a wireless device over an at least partially wireless connection according to some embodiments of the present disclosure;

FIG. 7 is a block diagram of an alternative embodiment of a host computer according to some embodiments of the present disclosure;

FIG. 8 is a block diagram of an alternative embodiment of a network node according to some embodiments of the present disclosure;

FIG. 9 is a block diagram of an alternative embodiment of a wireless device according to some embodiments of the present disclosure;

FIG. 10 is a flowchart illustrating exemplary methods implemented in a communication system including a host computer, a network node and a wireless device for executing a client application at a wireless device according to some embodiments of the present disclosure;

FIG. 11 is a flowchart illustrating exemplary methods implemented in a communication system including a host computer, a network node and a wireless device for receiving user data at a wireless device according to some embodiments of the present disclosure;

FIG. 12 is a flowchart illustrating exemplary methods implemented in a communication system including a host computer, a network node and a wireless device for receiving user data from the wireless device at a host computer according to some embodiments of the present disclosure;

FIG. 13 is a flowchart illustrating exemplary methods implemented in a communication system including a host computer, a network node and a wireless device for receiving user data at a host computer according to some embodiments of the present disclosure;

FIG. 14 is a flowchart of an exemplary process in a network node for DCI message format selection according to some embodiments of the present disclosure.

FIG. 15 is a flowchart of an exemplary process in a wireless device for DCI message format selection according to some embodiments of the present disclosure; and

FIG. 16 is an illustration of an example of dynamic switching between down link control information (DCI) usage modes based on channel quality index thresholds.

### DETAILED DESCRIPTION

Before describing in detail exemplary embodiments, it is noted that the embodiments reside primarily in combinations of apparatus components and processing steps related to DCI message size selection and formatting based at least in part on reliability. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), relay node, access point, radio access point, Remote Radio Unit (RRU) Remote Radio Head (RRH).

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments provide methods and systems for downlink control information (DCI) message size selection and formatting based at least in part on reliability. According to one aspect, a network node determines a format of a DCI message based at least in part on a service type provided to the WD, a characteristic of a physical downlink control channel, or a measure of channel quality. The network node also transmits the DCI message of the selected size and determined format to a wireless device (WD). According to another aspect, a WD determines a downlink control information, DCI, message format. The WD also decodes the DCI message based on the determined format, the format being based on one or more of: a service type provided to the WD, a characteristic of a physical downlink control channel, and a measure of channel quality. The criteria upon which the DCI message format determination is based may also include, slot size, periodicity of scheduling requests and service requirements.

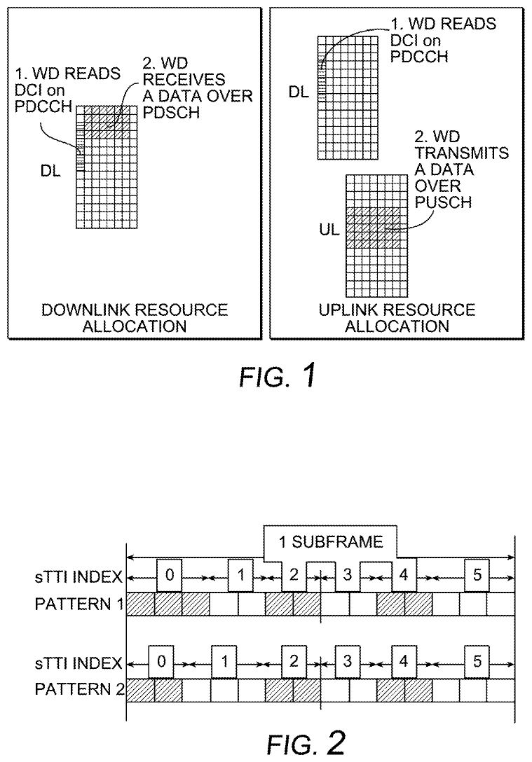

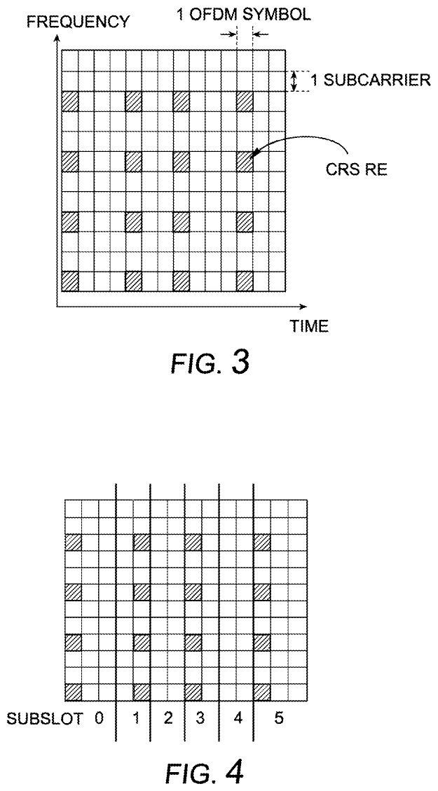

Returning now to the drawing figures, in which like elements are referred to by like reference numerals, there is shown in FIG. 1 a schematic diagram of a communication system, according to an embodiment, including a communication system 10, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16c. A second WD 22b in coverage area 18b is wirelessly connectable to the corresponding network node 16a. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WS 22 can be in communication with an eNB for LTE/E-UTRAN, and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

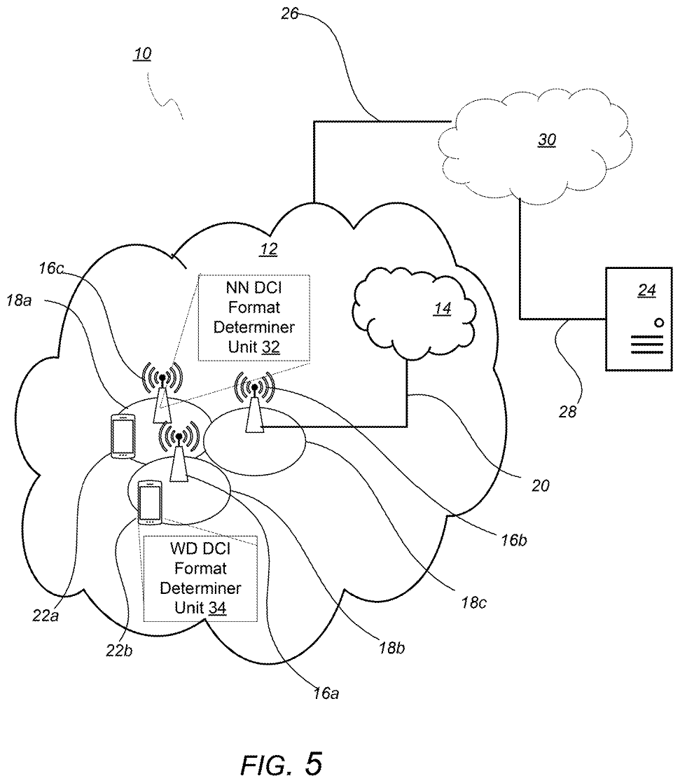

The communication system of FIG. 5 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 may be configured to include a NN DCI size format determiner unit 32 which is configured to select a format of a DCI message, from a set of at least two DCI message formats based on one or more of a service type provided to the WD 22, a characteristic of a physical downlink control channel, and a measure of channel quality. A wireless device 22 is configured to include a WD DCI message format determiner unit 34 which may be configured to determine a DCI message format. Note that in some cases, choosing the format will also determine the size of the DCI message.

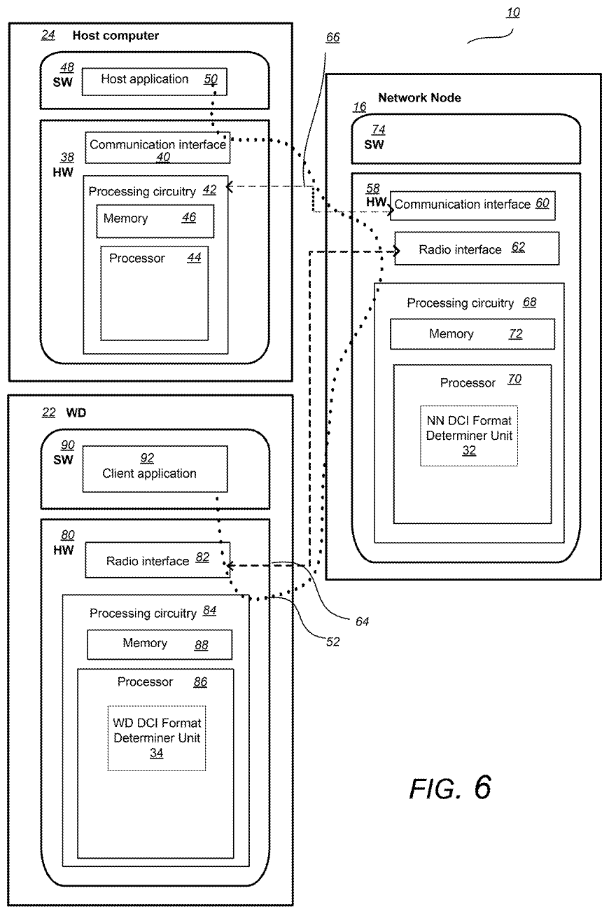

Example implementations, in accordance with an embodiment, of the WD 22, network node 16 and host computer 24 discussed in the preceding paragraphs will now be described with reference to FIG. 6. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor such, as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22.

The communication system 10 further includes a network node 16 provided in a communication system 10 and comprising hardware 58 enabling the communication system 10 to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or the connection 66 may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor such, as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include a NN DCI format determiner unit 32 which is configured to select a format of a DCI message from a set of at least two DCI message formats based at least on one or more of a service type provided to the WD 22, a characteristic of a physical downlink control channel, or a measure of channel quality.

The communication system 10 further includes the WD 22 already referred to. The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor such, as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that the client application 92 provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a WD DCI format determiner unit 34 which may be configured to determine a DCI format, which, in some embodiments, may be based on information received from the network node 16 on RRC signaling.

In FIG. 6, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which may be configured to be hidden from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 5 and 6 show various “units” such as NN DCI format determiner unit 32 and WD DCI format determiner unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

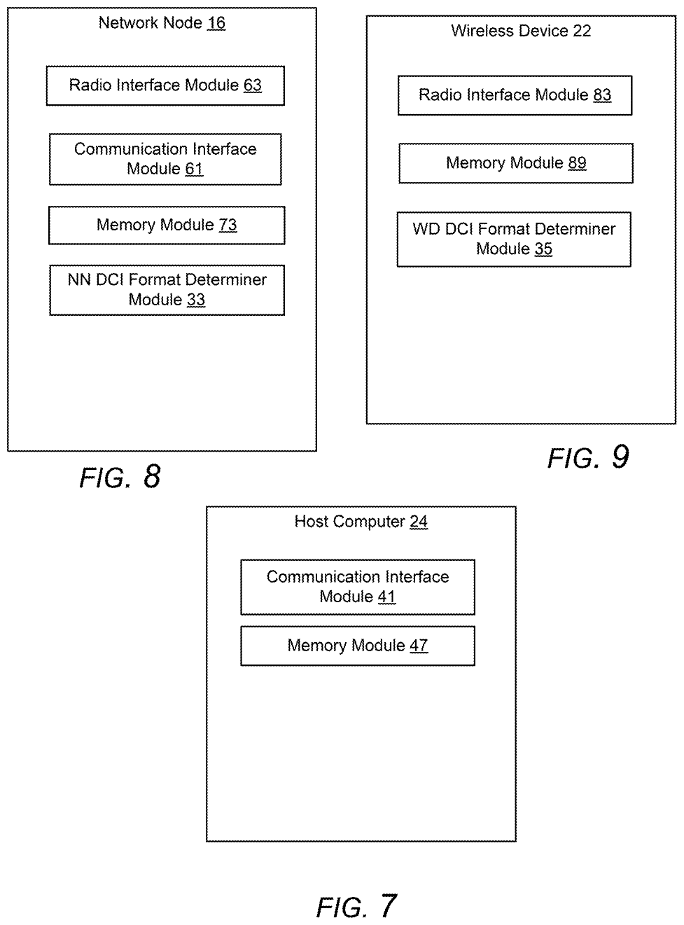

FIG. 7 is a block diagram of an alternative host computer 24, which may be implemented at least in part by software modules containing software executable by a processor to perform the functions described herein. The host computer 24 include a communication interface module 41 configured to set up and maintain a wired or wireless connection with an interface of a different communication device of the communication system 10. The memory module 47 is configured to store data, programmatic software code and/or other information described herein.

FIG. 8 is a block diagram of an alternative network node 16, which may be implemented at least in part by software modules containing software executable by a processor to perform the functions described herein. The network node 16 includes a radio interface module 63 configured for setting up and maintaining at least a wireless connection 64 with a WD 22 located in a coverage area 18 served by the network node 16. The network node 16 also includes a communication interface module 61 configured for setting up and maintaining a wired or wireless connection with an interface of a different communication device of the communication system 10. The communication interface module 61 may also be configured to facilitate a connection 66 to the host computer 24. The memory module 73 that is configured to store data, programmatic software code and/or other information described herein. The NN DCI format determiner module 33 is configured to select a format of a DCI message from a set of at least two DCI message formats based at least in part on a service type provided to the WD 22, a characteristic of a physical downlink control channel, or a measure of channel quality.

FIG. 9 is a block diagram of an alternative wireless device 22, which may be implemented at least in part by software modules containing software executable by a processor to perform the functions described herein. The WD 22 includes a radio interface module 83 configured to set up and maintain a wireless connection 64 with a network node 16 serving a coverage area 18 in which the WD 22 is currently located. The memory module 89 is configured to store data, programmatic software code and/or other information described herein. The WD DCI format determiner module 35 is configured to select a DCI message format, which may be based on information received from the network node 16 on RRC signaling.

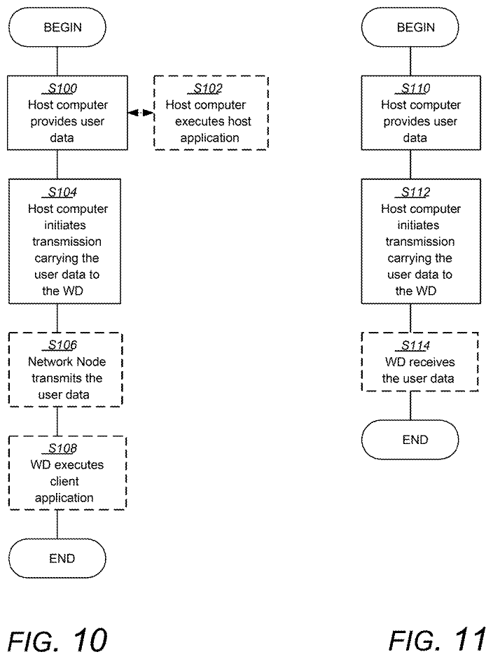

FIG. 10 is a flowchart illustrating an exemplary method implemented in a communication system, such as, for example, the communication system of FIGS. 5 and 6, in accordance with one embodiment. The communication system may include a host computer 24, a network node 16 and a WD 22, which may be those described with reference to FIG. 6. In a first step of the method, the host computer 24 provides user data (block S100). In an optional substep of the first step, the host computer 24 provides the user data by executing a host application, such as, for example, the host application 74 (block S102). In a second step, the host computer 24 initiates a transmission carrying the user data to the WD 22 (block S104). In an optional third step, the network node 16 transmits to the WD 22 the user data which was carried in the transmission that the host computer 22 initiated, in accordance with the teachings of the embodiments described throughout this disclosure (block S106). In an optional fourth step, the WD 22 executes a client application, such as, for example, the client application 114, associated with the host application 74 executed by the host computer 24 (block S108).

FIG. 11 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In a first step of the method, the host computer 24 provides user data (block S110). In an optional substep (not shown) the host computer 24 provides the user data by executing a host application, such as, for example, the host application 74. In a second step, the host computer 24 initiates a transmission carrying the user data to the WD 22 (block S112). The transmission may pass via the network node 16, in accordance with the teachings of the embodiments described throughout this disclosure. In an optional third step, the WD 22 receives the user data carried in the transmission (block S114).

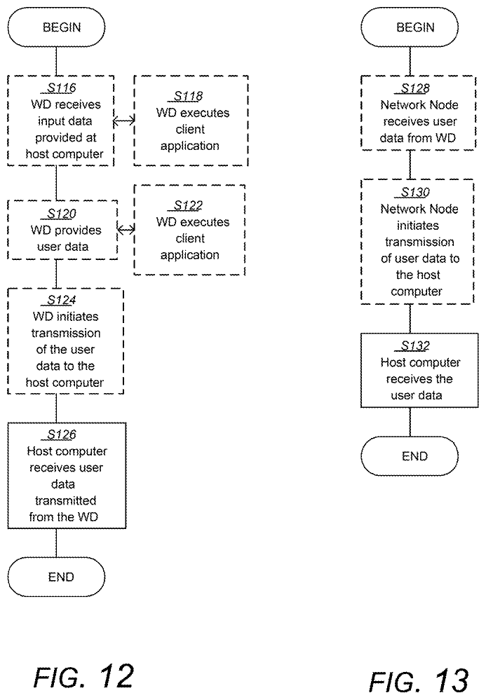

FIG. 12 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, the WD 22 receives input data provided by the host computer 24 (block S116). In an optional substep of the first step, the WD 22 executes the client application 114, which provides the user data in reaction to the received input data provided by the host computer 24 (block S118). Additionally or alternatively, in an optional second step, the WD 22 provides user data (block S120). In an optional substep of the second step, the WD provides the user data by executing a client application, such as, for example, client application 114 (block S122). In providing the user data, the executed client application 114 may further consider user input received from the user. Regardless of the specific manner in which the user data was provided, the WD 22 may initiate, in an optional third substep, transmission of the user data to the host computer 24 (block S124). In a fourth step of the method, the host computer 24 receives the user data transmitted from the WD 22, in accordance with the teachings of the embodiments described throughout this disclosure (block S126).

FIG. 13 is a flowchart illustrating an exemplary method implemented in a communication system, such as, for example, the communication system of FIG. 5, in accordance with one embodiment. The communication system may include a host computer 24, a network node 16 and a WD 22, which may be those described with reference to FIGS. 5 and 6. In an optional first step of the method, in accordance with the teachings of the embodiments described throughout this disclosure, the network node 16 receives user data from the WD 22 (block S128). In an optional second step, the network node 16 initiates transmission of the received user data to the host computer 24 (block S130). In a third step, the host computer 24 receives the user data carried in the transmission initiated by the network node 16 (block S132).

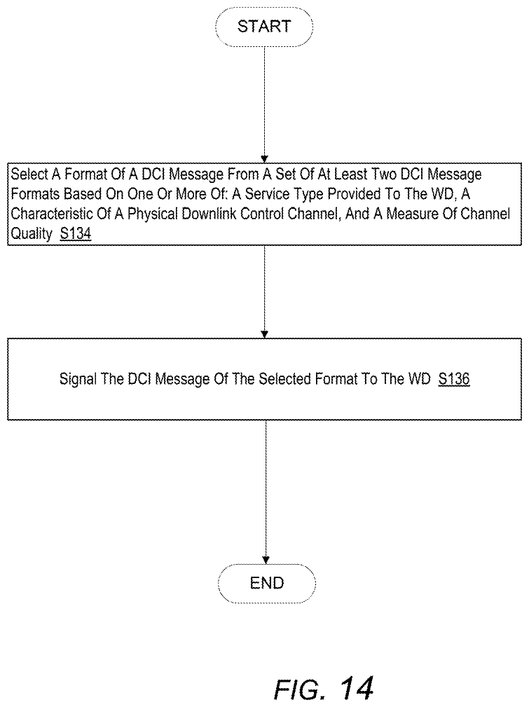

FIG. 14 is a flowchart of an exemplary process in a network node 16 for DCI message format selection in accordance with the principles of the present disclosure. One or more blocks described herein may be performed by one or more elements of network node 16 such as by one or more of processing circuitry 68 (including the NN DCI format determiner unit 32), processor 70, radio interface 62 and/or communication interface 60. Network node 16 such as via processing circuitry 68 and/or processor 70 and/or radio interface 62 and/or communication interface 60 is configured to select, via an NN DCI format determiner unit 32, a format of a DCI message from a set of at least two DCI message formats based at least in part on a service provided to the WD, a characteristic of a physical downlink control channel or a measure of channel quality (block S134). The process also includes signaling the DCI message of the selected format to the WD 22 (block S136).

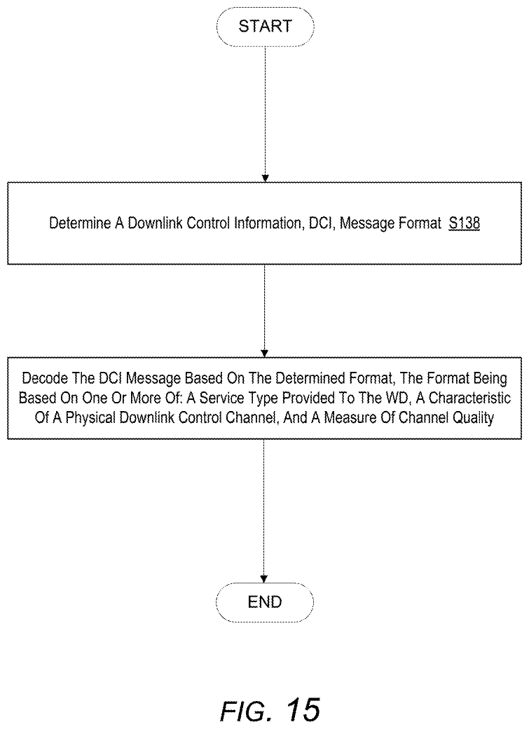

FIG. 15 is a flowchart of an exemplary process in a wireless device 22 for DCI message format selection according to some embodiments of the present disclosure. One or more Blocks described herein may be performed by one or more elements of wireless device 22 such as by one or more of processing circuitry 84 (including the WD DCI format determiner unit 34), processor 86, radio interface 82 and/or communication interface 60. Wireless device 22 such as via processing circuitry 84 and/or processor 86 and/or radio interface 82 is configured to determine a DCI message format (Block S138). The process also includes decoding the DCI message based on the determined format, the format being based on one or more of: a service type provided to the WD (22), a characteristic of a physical downlink control channel, and a measure of channel quality (Block S140).

Having described the general process flow of arrangements of the disclosure and having provided examples of hardware and software arrangements for implementing the processes and functions of the disclosure, the sections below provide details and examples of arrangements for determining downlink control information message size selection and formatting based on reliability.

Details and examples as to how the DCI message format may be selected and the DCI message format may be determined are provided below. Some embodiments assume there are at least two payload formats of the DCI message that can be used for operation with a given WD 22. In the following, only two DCI message formats—normal and compact—are considered but the principles are easily extendable to more than two DCI message formats. It is further assumed that the size of DCI message type A (compact) is smaller than the size of DCI message type B (normal), and that using type A, due to its smaller size, may impose restrictions on the network operation. Hence, the use of type A may be limited to cases where the performance is limiting and hence a restriction in network operation is motivated by a more robust DCI operation. The new type of DCI message of small size (which may be very compact) makes it possible to achieve lower channel coding rates, thereby increasing reliability of DCI message transmission. Note that a normally formatted DCI message may result in a DCI message size that is greater than the DCI message size of a compactly formatted DCI message.

Some embodiments include selecting a subset of DCI message formats from a larger set, based on one or more of:
A given quality based criteria, e.g., a range of SNR conditions, channel quality index (CQI) feedback, etc.;
The subframe or slot or subslot in which the DCI message is transmitted;
The physical channel to which the DCI message is mapped;
The periodicity and/or number of repetitions configured for scheduling requests; and
Configured service requirements.

Other criteria may be used as well and embodiments are not limited solely to the above list. Hence, the WD 22 may operate in one of three modes:
Normal DCI message format usage;
Compact DCI message format usage; and
Both normal and compact DCI message format usage.

The use of one of the modes depends on the listed embodiments, further elaborated below.

Considering the fact that a short/compact DCI message may increase reliability under poor radio conditions, in one embodiment, the compact DCI message format is selected by the NN DCI format determiner unit 32 and applied in case the WD 22 experiences poor radio conditions or poor channel quality. On the other hand, a normal DCI message size and format may be used in other cases. The radio interface 62 of the network node 16 sends information to the WD 22 from which the WD 22 can discern and select, via the WD DCI format determiner unit 34, the same DCI message format selected by the NN DCI format determiner unit 32. In other words, information may be sent from the network node 16 to the WD 22 to enable the WD 22 to select the same DCI message format selected by the network node 16. Note that the selected format may also determine the size of the DCI message.

The following measures of radio condition or quality can be used for determining the mode of operation (i.e., whether a compact or normal DCI message format is used). It should be noted that the list may not be exhaustive:
Radio condition metrics, such as measured SNR, SINR, reference signal received power (RSRP), reference signal received quality (RSRQ), etc.;
Number of configured repetitions of data transmissions and type of repetition scheme;

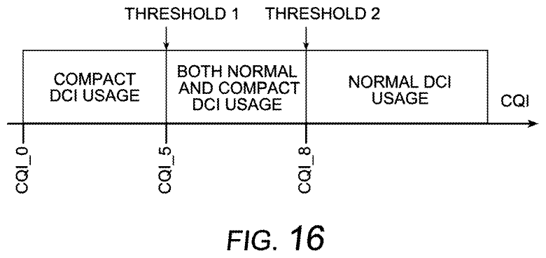

System specific related estimators include Channel Quality Indicator (CQI), measured Timing Advance (TA), etc. An example is shown in FIG. 16, which is a diagram of dynamic switching between DCI message use modes based on CQI thresholds. FIG. 16 shows an example where a compact DCI message is used when the CQI is below a first threshold 1, both normal and compact DCI messages are used when the CQI is greater than threshold 1 but less than a second threshold 2, and a normal DCI message is used when the CQI is higher than the second threshold 2. In some embodiments, the network node 16, via the radio interface 62, sends the threshold values to the WD 22 via RRC signaling.

The selection of operating mode, i.e., the selection of the format of the DCI message to be applied in the downlink channel to be received by the radio interface 82 of the WD 22, can be performed according to the below embodiments. The selecting may be based on:
Predefined switching order in DCI from the network node 16 to the WD 22;
Thresholds preconfigured in RRC signaling;
Sets of thresholds preconfigured in RRC signaling with the network node 16 sending a list of thresholds, which are a subset of the configured set of thresholds, to the WD 22 by dynamic signaling (DCI);
Information/parameter values signaled on the physical layer, e.g., slot format indicator on Group Common PDCCH;
Information/parameter values from any other signaling procedures; and
In yet another embodiment, the WD 22 may use event driven reporting to switch between modes: (for example, events 1A and 1B are reported to the network node 16 automatically when a WD 22 measures the received signal quality to be better or worse than a threshold, respectively).

In some embodiments, the compact DCI message is not used in every transmission opportunity, e.g., slot, subslot or subframe. The reference signal overhead may vary over time. In some OFDM symbols, cell specific reference signals (CRS) are present and thus fewer resource elements are available for the transmission of a downlink control channel such as the short physical downlink control channel (SPDCCH). If the DCI message of the same size is to be sent in a slot or subslot with more reference signal overhead, the coding rate for this DCI message may be higher and the probability of erroneous decoding increases. Therefore, it may not be an advantage to use the compact DCI message in a slot or subslot with higher reference signal overhead. In the slot or subslot instances with lower reference signal overhead, there may be an advantage to using the normal DCI message, which provides more flexibility to the scheduler.

In some embodiments, a time pattern indicates for which transmission opportunity (slot, subslot or subframe) the compact DCI message is applied. This time pattern can be RRC-configured or fixed by specification. Thus, in some embodiments, the radio interface 62 of the network node 16 can signal the WD 22 by RRC signaling to configure the WD 22 to select DCI message sizes according to the time pattern. This embodiment may also apply to cases where the transmission starting position and duration is not fixed (such as transmission type B in NR) and hence a single time pattern would not be applicable.

In another embodiment, the use of the DCI message is not based on a pattern but a metric, such as the number of resources that are removed in the mapping to physical resources of the control channel. This can be, for example, due to CRS-symbols, demodulation reference signal (DMRS) symbols and/or channel state information reference signal (CSI-RS) symbols. The threshold(s) for applying the different DCI message formats could be fixed in a specification or signaled to the WD 22 by the radio interface 62 of the network node 16 semi-statically by RRC signaling.

As mentioned above, the DCI message for scheduling a transmission can be transmitted on different downlink control channels. For instance, the DCI message of the first LTE slot or subslot of a subframe may be transmitted on the PDCCH, while the DCI message for other LTE slots or subslots may be transmitted on the SPDCCH. As mentioned above, the number of resource elements (REs) per (short) control channel element (CCE) may be different for the PDCCH and the SPDCCH.

Therefore, there may be an advantage to using the compact DCI message on a downlink control channel with fewer REs per control channel element (CCE) and to use the DCI message of normal size on a downlink control channel with more REs per CCE. This is just one example of a different characteristic between two different downlink control channels affecting which format of DCI message is to be selected by the NN DCI format determiner unit 32 of the network node 16. Other different characteristics may justify using the compact DCI message only for one of the downlink control channels that the WD 22 is monitoring. For instance, the use of a transmit diversity or beamforming scheme on one channel and not another may justify that the other channel will have a worse decoding performance and would require a smaller DCI message size. As noted above, a particular chosen format may result in a particular size of the DCI message for supporting the chosen format.

In some embodiments, the use of the compact DCI message is configured per downlink control channel monitored by the WD 22. Note that these embodiment can be combined with an embodiment described above where a compact DCI message is not used in every transmission if a WD 22 monitors a given downlink control channel at pre-defined time instances. Such embodiments can be used to make sure that at those pre-defined time instants the compact DCI message is used. Also note that such monitoring can also be performed independently of whether the WD 22 monitors a specific DCI message. This can be the case if for instance a WD 22 is expected to monitor two downlink control channels in the same transmission opportunity, e.g., if both the PDCCH and the EPDCCH are monitored in the same subframe.

As stated previously, the highest aggregation level (AL) on the PDCCH or SPDCCH and the size of DCI message limit the DCI message transmission reliability. Since there is a maximum AL size that is supported in the system, in one embodiment, the compact DCI message is used only for certain aggregation levels, e.g., the highest supported aggregation level. In such embodiments, even if the normal DCI message size may be impossible to reliably transmit, there is still an option to provide some robust control signaling, at the cost of a less detailed DCI message format. This can be applied both on the PDCCH as well as the SPDCCH. The compact DCI message can be the only DCI message format used for a certain AL, or the compact DCI message can be used in addition to a normal DCI message (which may increase the number of blind decodes).

In some embodiments, the list of valid aggregation levels for compact DCI messaging is fixed. In other embodiments, the list of valid aggregation levels for compact DCI messaging is semi-statically configured via RRC signaling from the radio interface 62 of the network node 16. In some embodiments, the use of compact DCI messaging for an uplink (UL) grant is associated with scheduling request (SR) periodicity. For example, when small SR periodicity is configured, implying low latency and high reliability UL traffic, the compact DCI message may be used for the UL grant.

In some embodiments, the use of a compact DCI message is based on the service associated with the WD 22. The service could be determined by:
The quality of service class identifier (QCI)/5QI profile that is configured;
The transmission time interval (TTI) lengths associated with the logical channel; and/or
Any other service indication configured to the WD 22.

The conditions on how to apply the compact DCI message based on the configured service, if more than one service is configured could, for example, be based on the most demanding service. For example, if the WD 22 is configured with only a mobile broadband (MBB) service profile, the normal DCI message may be used, while if the WD 22 is configured with a URLLC service profile the compact DCI message may be used. This can be done because URLLC requires lower latency than MBB. If the WD 22 is configured with both service profiles, it may be the URLLC service that determines the DCI message format to use (i.e., compact).

Detailed below are some of the possible solutions to shorten the DCI message size to achieve a compact DCI message size. The following fields can be reduced or deleted:
resource allocation;
modulation and coding scheme (MCS);
HARQ process field;
sounding reference signal (SRS)/CQI request, which can be removed and configured via other DCI message formats;
Cyclic shift for DMRS and orthogonal cover code (OCC) index and interleaved frequency division multiple access (IFDMA) configuration. In the UL DCI message of LTE, this field is 3 bits long and indicates the OCC and UL DMRS configuration for a physical uplink shared channel (PUSCH) transmission. For an LTE URLLC WD 22, this field could be reduced to 1 or 2 bits.
Localized/Distributed visual resource block (VRB) assignment flag. In the DL DCI message for transmission mode (TM) 1A, this field specifies if resource allocation type 2 follows a distributed or localized mapping. For LTE URLLC WDs 22, frequency diversity may be useful. Therefore, this field can be removed and a distributed resource allocation can be applied for LTE URLLC WDs 22. Alternatively, an RRC-signaled configuration can be used to indicate if the random access (RA) type 2 follows a localized or distributed mapping.
The transmission power control (TPC) field can be removed, with the WD 22 being power controlled by a separate DCI format 3 message. DCI format 3 is a TPC-only message where multiple WDs 22 are assigned a TPC command in the message via RRC signaling and follows a specific TPC-radio network temporary identifier (RNTI).
The physical uplink control channel (PUCCH) resource indication field can be removed. Information about HARQ resource and timing can be preconfigured, e.g., with a value corresponding to the earliest PUCCH opportunity.

In contrast with streaming traffic, low latency services, like URLLC, have a sporadic traffic model, when data arrives periodically of semi-periodically with relatively long pauses in between, e.g. once per second. Moreover, the HARQ timeline for low latency service tends to be as short as possible, which almost eliminates overlapping of two HARQ processes in time. Therefore, the field indicating a HARQ process can be shortened or even omitted. The following options are proposed:
In one embodiment, the HARQ process field can be 1 or 2 bits, allowing 2 or 4 simultaneous processes.
In another embodiment, the HARQ process field is omitted from the DCI message, allowing only one HARQ process signaling.

Despite shortening or omitting the field, some rules are proposed below to have a mapping between normal HARQ processes numeration.
In case of omitting or shortening of the HARQ process field, the WD 22 and network node 16 can assume that compact DCI always signals the process number 0 (or any other allowed number) or maintain a mapping table between signaled and legacy HARQ numbers.
In case of omitting the HARQ process field, the WD 22 and network node 16 can assume that compact DCI always signals the special process dedicated for low latency data transmission such as URLLC.

Thus, in some embodiments, a network node 16 is configured to communicate with a wireless device, WD 22. The network node 16 includes processing circuitry configured to select a format of a Downlink Control Information, DCI, message from a set of at least two DCI message formats based on one or more of: a service type provided to the WD 22, a characteristic of a physical downlink control channel, and a measure of channel quality. The processing circuitry is further configured to signal the DCI message of the selected format to the WD 22.

According to this aspect, in some embodiments, the selected format is for a size selected to be a smaller one of two different DCI message sizes when the service type requires lower latency than other service types provided to the WD 22. In some embodiments, the service type is Ultra Reliable Low Latency Communication, URLLC. In some embodiments, the format is selected based at least in part on an aggregation level of a Physical Downlink Control Channel, PDCCH. In some embodiments, the selected format is for a size selected to be a smaller one of two different DCI message sizes based on a length of the physical downlink control channel. In some embodiments, the measure of channel quality is a Channel Quality Index, measured Timing Advance, TA, a Signal to Noise Ratio, SNR, a Signal to Interference plus Noise Ratio, SINR, a Reference Signal Received Power, RSRP, or a Reference Signal Received Quality, RSRQ. In some embodiments, selecting a format of the DCI message based on a measure of channel quality includes comparing the measure of channel quality to at least one threshold. In some embodiments, the at least one threshold is sent to the WD 22 by Radio Resource Control, RRC, signaling. In some embodiments, the format of the DCI message that is selected depends on which one of a subframe, slot or subslot of the physical downlink control channel the DCI message is transmitted. In some embodiments, the format of the DCI message that is selected depends on a periodicity or a number of repetitions configured for scheduling requests.

According to another aspect, a method in a network node 16 configured to communicate with a wireless device, WD 22 is provided. The method includes selecting (S134) a format of a Downlink Control Information, DCI, message from a set of at least two DCI message formats based on one or more of: a service type provided to the WD 22, a characteristic of a physical downlink control channel, and a measure of channel quality. The method also includes signaling (S136) a DCI message of the selected format to the WD 22.

According to this aspect, in some embodiments, the selected format is for a size selected to be a smaller one of two different DCI message sizes when the service type requires lower latency than other service types provided to the WD 22 In some embodiments, the service type is size is Ultra Reliable Low Latency Communication, URLLC. In some embodiments, the format is selected based at least in part on an aggregation level of a Physical Downlink Control Channel, PDCCH. In some embodiments, the format is for a size selected to be a smaller one of two different DCI message sizes based on a length of the physical downlink control channel. In some embodiments, the measure of channel quality is a Channel Quality Index, measured Timing Advance, TA, a Signal to Noise Ratio, SNR, a Signal to Interference plus Noise Ratio, SINR, a Reference Signal Received Power, RSRP, or a Reference Signal Received Quality, RSRQ. In some embodiments, selecting a format of the DCI message based on a measure of channel quality includes comparing the measure of channel quality to at least one threshold. In some embodiments, the at least one threshold is sent to the WD 22 by Radio Resource Control, RRC, signaling. In some embodiments, the format of the DCI message that is selected depends on which one of a subframe, slot and subslot of the physical downlink control channel the DCI message is transmitted. In some embodiments, the format of the DCI message that is selected depends on a periodicity or a number of repetitions configured for scheduling requests.

According to yet another aspect, a wireless device, WD 22, configured to communicate with a network node 16 is provided. The WD 22 includes processing circuitry configured to determine a downlink control information, DCI, message format, and to decode the DCI message based on the determined format, the format being based on one or more of: a service type provided to the WD 22, a characteristic of a physical downlink control channel, and a measure of channel quality.

According to this aspect, in some embodiments, the DCI message format is determined via radio resource control, RRC, signaling from the network node. In some embodiments, the processing circuitry is further configured to determine at least one threshold which the WD 22 is configured to compare to a measure of channel quality to select a DCI message format. In some embodiments, the DCI message format indicates a size of the DCI message to be selected by the WD 22.

According to another aspect, method implemented in a WD 22 is provided. The method includes determining a downlink control information, DCI, message format, and decoding the DCI message based on the determined format, the format being based on one or more of: a service type provided to the WD 22, a characteristic of a physical downlink control channel, and a measure of channel quality.

According to this aspect, in some embodiments, the DCI message format is determined via radio resource control, RRC, signaling from the network node. In some embodiments, the method further includes determining at least one threshold which the WD 22 is configured to compare to a measure of channel quality to select a DCI message format. In some embodiments, the DCI message format indicates a size of the DCI message to be selected by the WD 22.

Some embodiments include the following:

Embodiment A1. A network node configured to communicate with a wireless device (WD), the network node configured to, and/or comprising a radio interface and/or comprising processing circuitry configured to:

determine a format of a downlink control information, DCI, based on a criteria known to the network node; and

transmit the DCI of the determined format to the WD.

Embodiment A2. The network node of Embodiment A1, wherein the determined format is a determined size.

Embodiment A3. The network node of Embodiment A1, wherein the criteria includes aggregation level.

Embodiment A4. The network node of Embodiment A1, wherein the criteria includes channel quality.

Embodiment A5. The network node of Embodiment A1, wherein the criteria includes whether the DCI is to be transmitted on one of a subframe, slot and subslot.

Embodiment A6. The network node of Embodiment A1, wherein the criteria includes periodicity of scheduling requests.

Embodiment A7. The network node of Embodiment A1, wherein the criteria includes service requirement.

Embodiment B1. A method implemented in a network node, the method comprising:

determining a format of a downlink control information, DCI, based on a criteria known to the network node; and

transmitting the DCI of the determined format to the WD.

Embodiment B2. The method of Embodiment B1, wherein the determined format is a determined size.

Embodiment B3. The method of Embodiment B1, wherein the criteria includes aggregation level.

Embodiment B4. The method of Embodiment B1, wherein the criteria includes channel quality.

Embodiment B5. The method of Embodiment B1, wherein the criteria is whether the DCI is to be transmitted on one of a subframe, slot and subslot.

Embodiment B6. The method of Embodiment B1, wherein the criteria includes periodicity of scheduling requests.

Embodiment B7. The method of Embodiment B1, wherein the criteria includes service requirement.

Embodiment C1. A wireless device (WD) configured to communicate with a network node, the WD configured to, and/or comprising a radio interface and/or processing circuitry configured to:

determine a format of downlink control information, DCI; and

decode the DCI based on the determined format of the DCI.

Embodiment C2. The WD of Embodiment C1, wherein the determined format is a determined size.

Embodiment C3. The WD of Embodiment C1, wherein the criteria includes aggregation level.

Embodiment C4. The WD of Embodiment C1, wherein the size is selected based on an indication from the network node.

Embodiment C5. The WD of Embodiment C1, wherein the size is selected based on a criteria known to the WD.

Embodiment D1. A method implemented in a wireless device (WD), the method comprising:

determining a format of downlink control information, DCI; and

decoding the DCI based on the determined format of the DCI.

Embodiment D2. The method of Embodiment D1, wherein the determined format is a determined size.

Embodiment D3. The method of Embodiment D1, wherein the criteria includes aggregation level.

Embodiment D3. The method of Embodiment D1, wherein the size is selected based on an indication from the network node.

Embodiment D4. The method of Embodiment D1, wherein the size is selected based on a criteria known to the WD.

Embodiment E1. A network node, comprising:
a memory module configured to store criteria upon which a format of a downlink control information, DCI, is based;
a DCI format determination module configured to determine a format of a downlink control information, DCI, based on a criteria known to the network node; and

a radio interface configured to transmit the DCI of the determined size to a WD.

Embodiment E2. A wireless device, comprising:
a memory module configured to store a downlink control information, DCI, format;
a DCI format determination module configured to determine a format of the DCI.

As will be appreciated by one of skill in the art, the concepts described herein may be embodied as a method, data processing system, and/or computer program product. Accordingly, the concepts described herein may take the form of an entirely hardware embodiment, an entirely software embodiment or an embodiment combining software and hardware aspects all generally referred to herein as a “circuit” or “module.” Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

Abbreviations that may be used in the preceding description include:

3GPP 3rd Generation Partnership Project

AL Aggregation Level

CCE Control Channel Elements

CQI Channel Quality Indicator

DCI Downlink Control Information

DL Downlink

HARQ Hybrid Automatic Repeat Request

LTE Long Term Evolution

MCS Modulation and Coding Scheme

NDI New Data Indicator

NR New Radio

PDCCH Physical Downlink Control Channel

PDSCH Physical Downlink Shared Channel

PUSCH Physical Uplink Shared Channel

RRM Radio Resource Management

RSRP Reference Signal Received Power

RSRQ Reference Signal Received Quality

RV Redundancy Version

SINR Signal-to-noise-plus-interference ratio

SNR Signal-to-Noise Ratio

TA Timing Advance

TPC Transmit Power Control

UE User Equipment

UL Uplink

URLLC Ultra Reliable Low Latency Communication

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A network node configured to communicate with a wireless device, WD, the network node comprising processing circuitry configured to:
select a format of a Downlink Control Information, DCI, message from a set of at least two DCI message formats based on at least one of: a service type provided to the WD, a characteristic of a physical downlink control channel, and a measure of channel quality; and
signal the DCI message of the selected format to the WD.

2. The network node of claim 1, wherein the selected format is for a size selected to be a smaller one of two different DCI message sizes when the service type requires lower latency than other service types provided to the WD.

3. The network node of claim 2, wherein the service type is Ultra Reliable Low Latency Communication, URLLC.

4. The network node of claim 1, wherein the format is selected based at least in part on an aggregation level of a Physical Downlink Control Channel, PDCCH.

5. The network node of claim 1, wherein the selected format is for a size selected to be a smaller one of two different DCI message sizes based on a length of the physical downlink control channel.

6. The network node of claim 1, wherein the measure of channel quality is one of a Channel Quality Index, measured Timing Advance, TA, a Signal to Noise Ratio, SNR, a Signal to Interference plus Noise Ratio, SINR, a Reference Signal Received Power, RSRP, and a Reference Signal Received Quality, RSRQ.

7. The network node of claim 1, wherein selecting a format of the DCI message based on a measure of channel quality includes comparing the measure of channel quality to at least one threshold.

8. The network node of claim 7, wherein the at least one threshold is sent to the WD by Radio Resource Control, RRC, signaling.

9. The network node of claim 6, wherein the format of the DCI message that is selected depends on which one of a subframe, slot or subslot of the physical downlink control channel the DCI message is transmitted.

10. The network node of claim 6, wherein the format of the DCI message that is selected depends on one of a periodicity a number of repetitions configured for scheduling requests.

11. A method in a network node configured to communicate with a wireless device, WD, the method comprising:
selecting a format of a Downlink Control Information, DCI, message from a set of at least two DCI message formats based on at least one of: a service type provided to the WD, a characteristic of a physical downlink control channel, and a measure of channel quality; and
signaling a DCI message of the selected format to the WD.

12. The method of claim 11, wherein the selected format is for a size selected to be a smaller one of two different DCI message sizes when the service type requires lower latency than other service types provided to the WD.

13. (canceled)

14. The method of claim 11, wherein the format is selected based at least in part on an aggregation level of a Physical Downlink Control Channel, PDCCH.

15. The method of claim 11, wherein the selected format is for a size selected to be a smaller one of two different DCI message sizes based on a length of the physical downlink control channel.

16. The method of claim 11, wherein the measure of channel quality is one of a Channel Quality Index, measured Timing Advance, TA, a Signal to Noise Ratio, SNR, a Signal to Interference plus Noise Ratio, SINR, a Reference Signal Received Power, RSRP, and a Reference Signal Received Quality, RSRQ.

17. The method of claim 11, wherein selecting a format of the DCI message based on a measure of channel quality includes comparing the measure of channel quality to at least one threshold.

18. (canceled)

19. The method of claim 16, wherein the format of the DCI message that is selected depends on which one of a subframe, slot and subslot of the physical downlink control channel the DCI message is transmitted.

20. The method of claim 16, wherein the format of the DCI message that is selected depends on one of a periodicity and a number of repetitions configured for scheduling requests.

21. A wireless device, WD, configured to communicate with a network node, the WD comprising processing circuitry configured to:
determine a downlink control information, DCI, message format; and
decode the DCI message based on the determined format, the format being based on at least one of: a service type provided to the WD, a characteristic of a physical downlink control channel, and a measure of channel quality.

22. The WD of claim 21, wherein the DCI message format is determined via radio resource control, RRC, signaling from the network node.

23. The WD of claim 21, wherein the processing circuitry is further configured to determine at least one threshold which the WD is configured to compare to a measure of channel quality to select a DCI message format.

24. The WD of claim 21 wherein the DCI message format indicates a size of the DCI message to be selected by the WD.

25. A method implemented in a wireless device, WD, the method comprising:
determining a downlink control information, DCI, message format; and
decoding the DCI message based on the determined format, the format being based on at least one of: a service type provided to the WD, a characteristic of a physical downlink control channel, and a measure of channel quality.

26. (canceled)

27. The method of claim 25, further comprising determining at least one threshold which the WD is configured to compare to a measure of channel quality to select a DCI message format.

28. (canceled)
